(19) United States
(12) Patent Application Publication
(10) Pub. No.: US 2002/0034007 A1
(43) Pub. Date: Mar. 21, 2002

(54) Lamination micro optical material

(76) Inventor: William M. Karszes, Rosewell, GA (US)

Correspondence Address: Laurence E. Stein, PATTON BOGGS LLP, 2550 M Street, N.W., Washington, DC, 20037, US

(21) Appl. No.: 09/953,432

(22) Filed: Sep. 17, 2001

Related U.S. Application Data
(60) Provisional application No. 60/232,846, filed on Sep. 15, 2000.

(51) Int. Cl. G02B 27/22

(52) U.S. Cl. 359/462

(57) ABSTRACT

An adhesive-backed lenticule or micro-lens array includes a heat-activated or pressure-activated transparent adhesive or bonding layer. An interphased image is fixed on a printable medium using a conventional printer. The adhesive-backed micro-lens array is aligned with the image and then activated using heat or pressure, to adhere the sheet and produce a final viewing product. An alignment edge of the adhesive-backed micro-lens array may be spaced and oriented relative to lenses or lenticules within the array. Alignment marks may be disposed on the medium proximal to the interphased image, for alignment with the alignment edge of the adhesive-backed micro-lens array.

Priority of this application is based on U.S. Provisional Application No. 60/232,846, filed on Sep. 15, 2000, which is hereby incorporated by reference.

### BACKGROUND OF THE INVENTION

1. Field of the Invention

This invention relates to fixation of viewable images and, more particularly, to a method and apparatus for fixing a merged image having a plurality of interphased images on a medium for three dimensional and angle dependent image viewing.

2. Statement of the Related Art

Multi-image graphics can be produced on personal computers (PC's) using interphasing software in conjunction with layering technology. These programs can output images off the PC printers that have amazing visual effects when viewed through a micro lens array. The problem becomes how to affix the lens array to the output in an easily defined manner. The lamination needs to be completed using readily available equipment, so that the average consumer will be capable of using the product with minimal directions. Known methods do not integrate the lamination or adhering function with the micro lens array and, instead, require a separate step of applying transparent double-stick tape or transparent adhesive to the micro-lens array, and then adhering that lamination to the interphased image. This separate step is cumbersome and prone to human error.

### SUMMARY OF THE INVENTION

The product, according to the present invention, accomplishes these objectives by combining a micro lens material, termed herein as a Micro Optical Material or MOM with adhesion layers. The MOM may formed from a single material or contain multiple layers, depending on the extrusion process(es) and on the mechanical properties of the end product requirements. The adhesive layer can be a transparent heat activated material such as, for example, Ethyl Vinyl Acetate (EVA) or Ethyl Methyl Acrylic Acid (EMA) If the adhesive layer is a heat activated material then a common heat laminator can be used such as those found in the office supply stores.

Alternatively, the adhesive layer may be a pressure sensitive. The adhesive must be clear and the release sheet used on the adhesive should also be clear. The lamination can be activated by a simple rolling action such as with a rolling pin or some other rolling device.

This invention allows anyone to permanently affix a MOM to a printed image with equipment available in any office supply store.

This invention addresses the need for an easy system to utilize personal computers (PCs) and PC printers to produce multi-image graphics, and view the results at the originating location. Numerous other features, objects and advantages of the invention will become apparent from the following description when read in conjunction with the accompanying drawings.

### BRIEF DESCRIPTION OF THE DRAWINGS

FIG. 1 depicts a cross-sectional view of an example micro-lens array or micro-optical material;

FIG. 2 shows the FIG. 1 micro-optical material with an example pre-applied adhesive backing for lamination onto a medium in accordance with the present invention;

FIG. 3 shows a front perspective view of an interphased master image affixed to an example medium, with horizontal and vertical edge guides for application of an adhesive-backed micro-optical material, such as that of FIG. 2, in accordance with the present invention;

FIG. 4 shows an example initial placement of an adhesive-backed micro-optical material of FIG. 2 onto the FIG. 3 master image with edge guides for completion of an overlay attachment of same in accordance with the present invention;

FIG. 5 shows an example preferred angular relation of the FIG. 2 adhesive-backed micro-optical material and the example FIG. 3 master image substrate for subsequent lamination in accordance with the present invention;

FIG. 6 shows an example pressure roller for completing a lamination of an adhesive-backed micro-optical material after being initially positioned as shown in FIG. 5;

FIG. 7 shows an example initial placement of an adhesive-backed micro-optical material onto the FIG. 3 master image with a temporary positioning tape for heat laminating; and

FIG. 8 shows a heat lamination arrangement for completing a lamination of an adhesive-backed micro-optical material in accordance with the present invention.

### DETAILED DESCRIPTION OF THE INVENTION

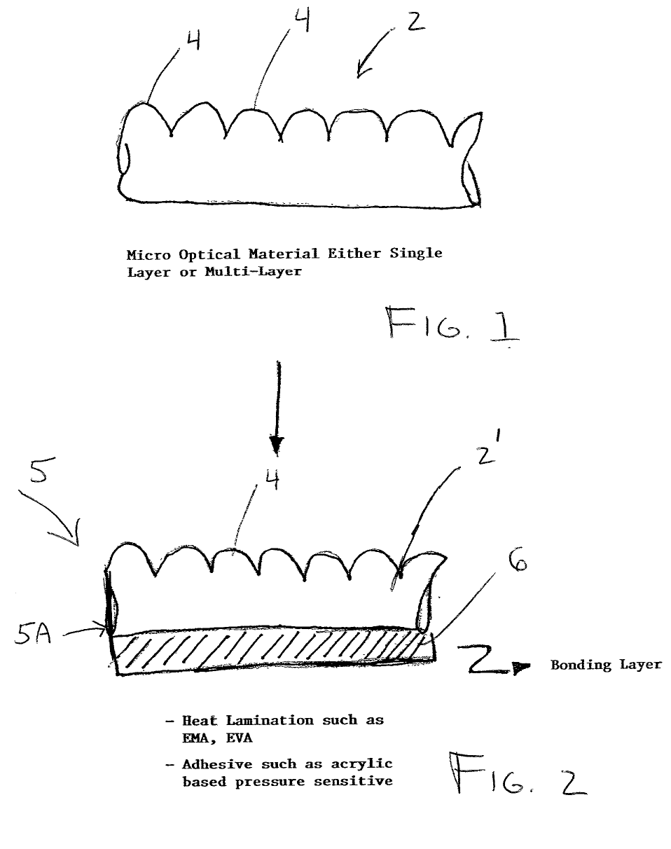

FIG. 1 depicts a cross-sectional view of an example micro-optical material (“MOM”) 2. The micro-optical material 2 comprises a plurality of parallel lenses 4 which are typically, but not necessarily, identical to one another. FIG. 2 shows a cross-sectional view of an example adhesive-backed MOM sheet 5 in accordance with the present invention, formed of a MOM 2′ such as that depicted as item 2 in FIG. 1 with an applied adhesive or bonding layer 6. The adhesive 6 may be a pressure activated adhesive such as, for example, an acrylic, or a heat-activated material such as EMA or EVA. The lenses 4 are typically semi-cylindrical in shape, as is depicted in the FIG. 1 example.

As will be understood from this description and the attached drawings, there is a required alignment of the lenses 4 of the MOM 5 to the printed image lines of a multi-phased image onto which the MOM 5 is adhered, as described below.

FIG. 3 shows a medium or image substrate 8 which may be, for example, a printable paper, on which a lined or raster-type interphased image 10 is fixed. The fixing may be by an ink-jet printer. Also fixed on the medium 8 is a first alignment mark or edge guide 12 and a second alignment mark or edge guide 14, each being perpendicular to the other. Typically the image 10 will have pixel or raster lines (not shown) extending parallel to only one of the edge guide lines 12 and 14. However, for purposes of a general description perpendicular lines 12 and 14 and shown.

It is assumed for this example that the pixel or raster lines within the image 10 extend parallel to the edge guide 12. The edge guide 12 is spaced a distance D from the nearest edge 10A of the image 10. Referring to FIG. 2, the distance D is such that when the edge 5A is on the edge guide 12, the lenses 4 are aligned properly, in the direction of the distance D, to extend parallel above the pixel or raster lines in the image 10.

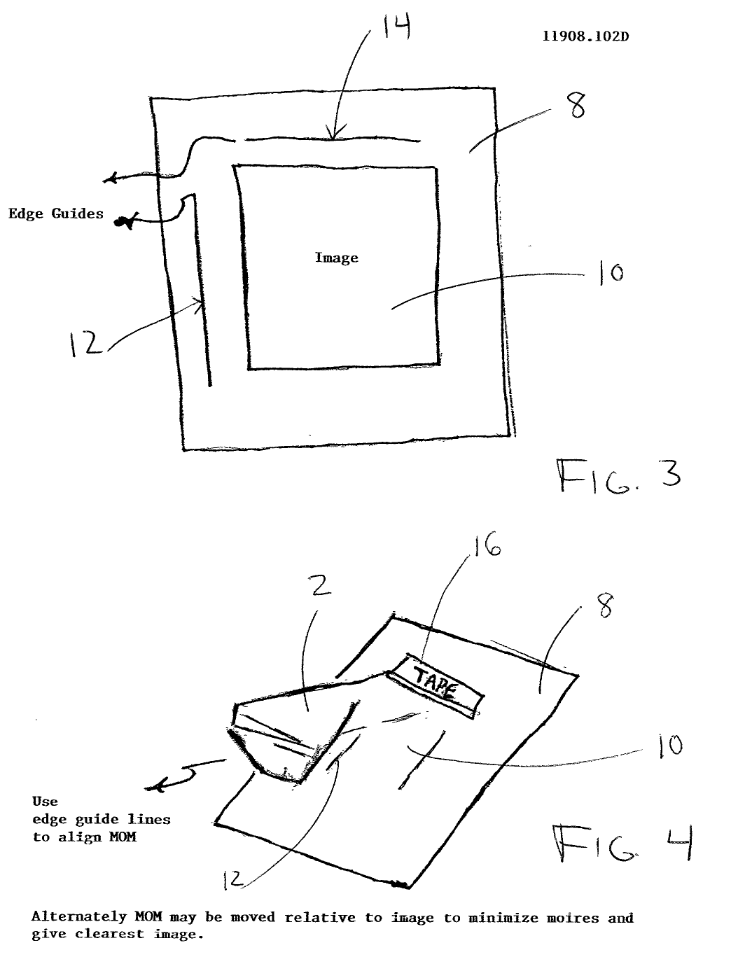

FIG. 4 shows an example initial placement of the FIG. 2 adhesive-backed MOM sheet 5 onto the medium 8 of FIG. 3, using the edge guide 12 (and/or 14) for alignment. Assuming that all of the following enumerated conditions are met, a maximum quality three-dimensional, flip or morphing image will be seen through MOM sheet 5 when it is adhered to the medium 8 over the image 10 with its edge 2A coincident with the edge guide 12: (i) the position and orientation of the image 10 is correct, within a predetermined tolerance, (ii) the edge guide 12 is correctly fixed, and (iii) the edge 2A of the MOM sheet 5 has been formed to be correctly spaced from and aligned with the lenses 4.

However, if any of these above-enumerated conditions are not met, the viewed image may not be as clean as it could be, and may have moiré lines. To compensate, the adhesive-backed MOM sheet may be moved slightly prior to adhering to the medium 8, in a left-right and/or rotational manner, until the moirés are minimized and the cleanest image is obtained. When this position is found the micro-optical material can be temporarily fixed using, for example, an adhesive tape 16.

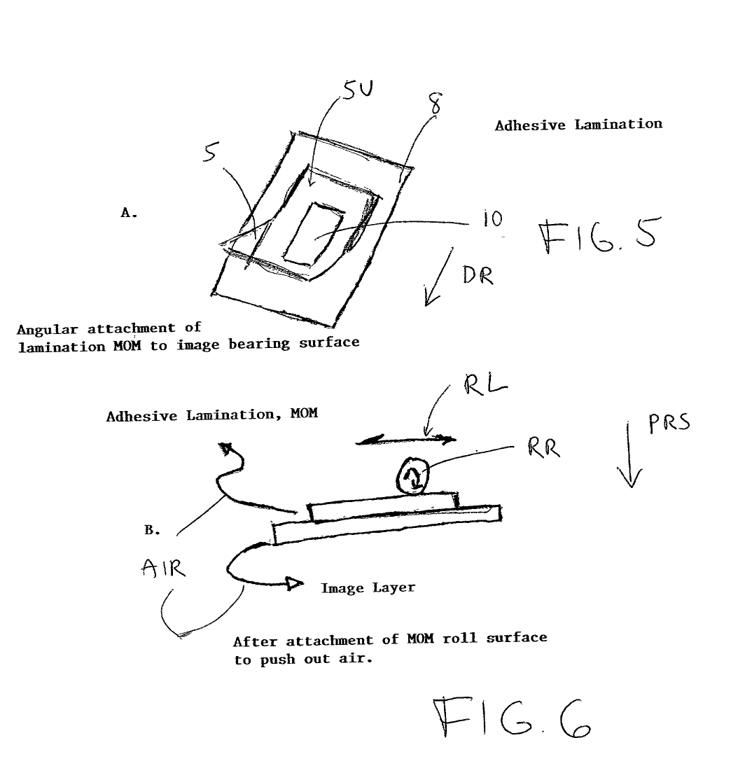

FIG. 5 shows an example preferred angular relation of the FIG. 2 adhesive-backed MOM 5 and the example FIG. 3 medium 8 with image 10, for subsequent adhering in accordance with the present invention. As shown, the upper region 5U of the MOM 5 is applied first and then, progressing in the DR direction, the remaining areas of the sheet 5 are brought into contact with the medium 8.

FIG. 6 shows an example method of pressing the MOM sheet to the medium 8, after being laid down in the above-described angular fashion to minimize air, to activate the adhesive and remove any air trapped at the interface between 5 and 8. As shown in FIG. 6 the example method is to apply pressure in the PRS direction to roller 18, and then roll it around the RR vector, to move forward and backward in the RL direction and force air, labeled as AIR, from underneath the MOM 5.

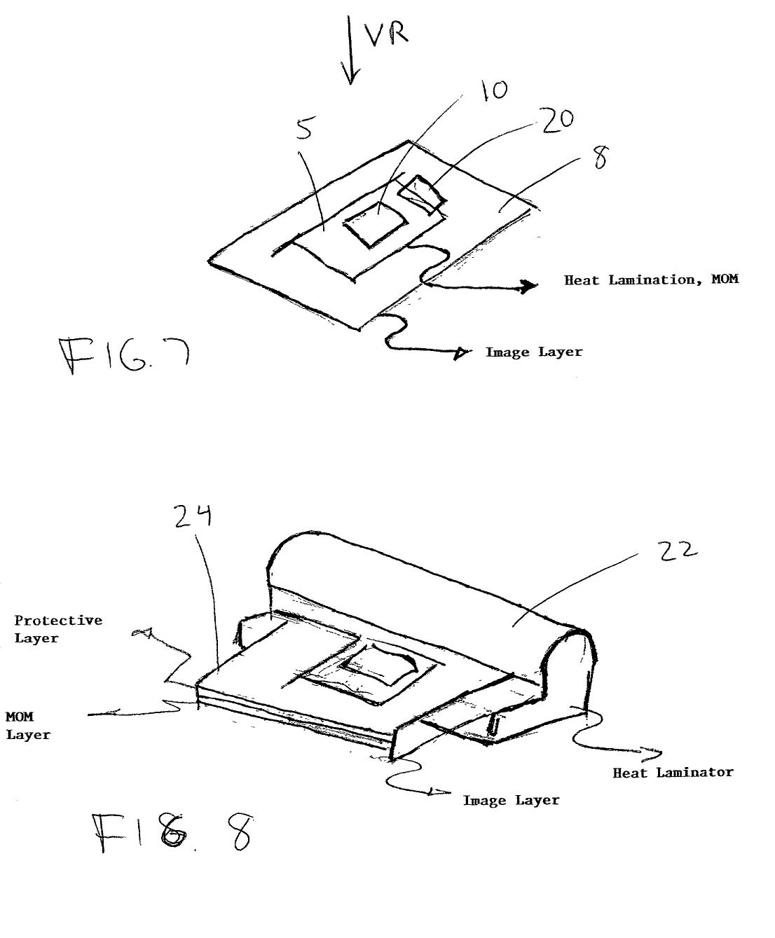

As described previously, the adhesive backed MOM sheet 5 may have a heat-activated adhesive or bonding layer 6. Using a heat-activated adhesive, the MOM sheet 5 is aligned with the medium 8 and image 10 using, for example, the edge guides 12 and 14 described above. As also described, the sheet 5 may be further adjusted in position to obtain the cleanest image, when viewed from, for example, the VR direction shown in FIG. 7. After the position is identified, the sheet 5 is temporarily fixed using, for example, adhesive tape 20. Next, as shown in FIG. 8, the medium 8 with image 10, with the adhesive-backed MOM 5 fixed by the tape 20, are inserted into a conventional commercially available heat-laminator 22.

Depending on the material from which the lenses or lenticules 4 are formed, a sacrificial sheet 24 may be used to protect the lenticules during the heat cycle. A sacrificial sheet 24 may, for example, be omitted when a hard resin is used for lenticules 4. Resins such as APET and PETG are, typically, sufficiently hard to omit the sacrificial protective layer 24.

After the MOM 5 is adhered to the medium 8 over the image 10, the medium 8 surrounding the image 10 may be trimmed.

The present invention as described above significantly reduces the complexity of applying a micro-optical medium to an interphased image for three-dimensional and for view-angle dependent images presentation such as flip and morphing. Previous methods require a separate step of placing an adhesive onto a MOM or MOM-like sheet. The present invention requires a simple operation that can be carried out by an unskilled person: Align the MOM 5 to the image 10, and apply pressure, or run the MOM 5 and medium 8 through a heat laminator.

It should be understood that the particular embodiments shown in the drawings and described within this specification are for purposes of example and should not be construed to limit the invention which will be described in the claims below.

1. A method for viewing a three-dimensional image, comprising steps of:
providing a medium having an interphased image fixed thereon;
providing a transparent micro-lens array sheet having a plurality of lenticules and a transparent adhesive layer under said plurality;
aligning the transparent micro-optic lens array sheet with the image by placing the transparent adhesive layer against the interphased image and moving said sheet laterally until a position is identified at which image clarity is maximized; and
activating said transparent adhesive layer when said transparent micro-optic lens array sheet is at said identified position.

2. A method according to claim 2 further comprising a step of fixing at least one visible alignment line on said medium having an interphased image fixed thereon and
wherein said step of providing a transparent micro-lens array sheet having a transparent adhesive layer provides said sheet with an edge which, when aligned with said at least one visible alignment line, provides a substantial alignment of said plurality of lenticules with said interphased image.

3. A method according to claim 1, further comprising a step of temporarily fixing said transparent micro-optic lens array sheet at said identified position prior until said step of activating said transparent adhesive layer is performed.

4. A method according to claim 2, further comprising a step of temporarily fixing said transparent micro-optic lens array sheet at said identified position prior until said step of activating said transparent adhesive layer is performed.

5. A method according to claim 1 wherein said transparent adhesive is a heat-activated adhesive and said step of activating said transparent adhesive applies heat to said adhesive.

6. A method according to claim 2 wherein said transparent adhesive is a heat-activated adhesive and said step of activating said transparent adhesive applies heat to said adhesive.

7. A method according to claim 3 wherein said transparent adhesive is a heat-activated adhesive and said step of activating said transparent adhesive applies heat to said adhesive.

8. A method according to claim 4 wherein said transparent adhesive is a heat-activated adhesive and said step of activating said transparent adhesive applies heat to said adhesive.

9. A method according to claim 1 wherein said transparent adhesive is a pressure-activated adhesive and said step of activating said transparent adhesive applies pressure to said adhesive.

10. A method according to claim 2 wherein said transparent adhesive is a pressure-activated adhesive and said step of activating said transparent adhesive applies pressure to said adhesive.

11. A method according to claim 3 wherein said transparent adhesive is a pressure-activated adhesive and said step of activating said transparent adhesive applies pressure to said adhesive.

12. A method according to claim 4 wherein said transparent adhesive is a pressure-activated adhesive and said step of activating said transparent adhesive applies pressure to said adhesive.
